(19) United States
(12) Patent Application Publication
(10) Pub. No.: US 2020/0174999 A1
(43) Pub. Date: Jun. 4, 2020

(54) METHOD AND SYSTEM FOR DYNAMICALLY UPDATING A PRODUCT MANUAL

(71) Applicant: WIPRO LIMITED, BANGALORE (IN)

(72) Inventors: Manjunath Ramachandra Iyer, Bangalore (IN); Sethuraman Ulaganathan, Tiruchirapalli (IN)

(21) Appl. No.: 16/261,630

(22) Filed: Jan. 30, 2019

(30) Foreign Application Priority Data
Nov. 30, 2018 (IN) 201841045312

(51) Int. Cl. G06F 16/23; G06F 16/9535; G06Q 30/00

(52) U.S. Cl. CPC G06F 16/2379; G06F 16/9535; G10L 15/1822; G06Q 30/01; G06F 16/2365

(57) ABSTRACT

Disclosed herein is a method and an information updating system for dynamically updating a product manual. In an embodiment, information related to product are received and analyzed to identify issues in handling the product. Thereafter, resolution information required for resolving the identified issues is extracted and compared with existing resolution information in the product manual to identify a missing portion of the product manual. Subsequently, the product manual is updated with the missing portion based on a logical resolution graph of the product manual. In an embodiment, the present disclosure helps in building comprehensive and reliable product manuals, thereby enhancing usability of the products.

### TECHNICAL FIELD

The present subject matter is, in general, related to dynamically updating a database and more particularly, but not exclusively, to a method and system for dynamically updating a product manual.

### BACKGROUND

Typically, product manuals reflect various features and technical information about usage and maintenance of products. Generally, contents of the product manuals are fixed and do not change unless the product release itself changes. Further, contents of the product manuals are usually collected based on design and usage of the products from a limited set of users, who would use the products for a short time during a pilot study of the product. However, the pilot study would generally be conducted for a short time, which may not be sufficient to find out any flaws in the usage of the products.

As a result, the product manuals may lack crucial information required for tackling some of the flaws that were not encountered during the pilot study. In such circumstances, users of the products must wait for a future product release to get the updated product manuals, which sufficiently discloses the required information. Therefore, it would be desirable to have the product manuals updated whenever contents related to the product are available.

The information disclosed in this background of the disclosure section is only for enhancement of understanding of the general background of the invention and should not be taken as an acknowledgement or any form of suggestion that this information forms the prior art already known to a person skilled in the art.

### SUMMARY

Disclosed herein is a method for dynamically updating a product manual. The method comprises receiving, by an information updating system, information related to a product from one or more data sources associated with the information updating system. Further, the method comprises analyzing the information related to the product using predetermined techniques for identifying one or more issues associated with handling the product. Thereafter, the method comprises extracting resolution information for resolving each of the one or more issues from one or more resolution databases. Upon extracting the resolution information, the method comprises identifying a portion of the resolution information missing in existing resolution information of the product manual based on a comparison of the resolution information with the existing resolution information. Finally, the method comprises updating the product manual with missing portion of the existing resolution information based on a logical resolution graph corresponding to the existing resolution information in the product manual.

Further, the present disclosure relates to an information updating system for dynamically updating a product manual. The information updating system comprises a processor and a memory. The memory is communicatively coupled to the processor and stores processor-executable instructions, which on execution, cause the processor to receive information related to a product from one or more data sources associated with the information updating system. Further, the instructions cause the processor to analyze the information related to the product using predetermined techniques to identify one or more issues associated with handling the product. Thereafter, the instructions cause the processor to extract resolution information for resolving each of the one or more issues from one or more resolution databases. Upon extracting the resolution information, the instructions cause the processor to identify a portion of the resolution information missing in existing resolution information of the product manual based on a comparison of the resolution information with the existing resolution information. Finally, the instructions cause the processor to update the product manual with missing portion of the existing resolution information based on a logical resolution graph corresponding to the existing resolution information in the product manual.

Furthermore, the present disclosure relates to a non-transitory computer readable medium including instructions stored thereon that when processed by at least one processor, cause an information updating system to perform operations comprising receiving information related to a product from one or more data sources associated with the information updating system. Subsequent to receiving the information related to the product, the instructions cause the processor to analyze the information related to the product using predetermined techniques to identify one or more issues associated with handling the product. Thereafter, the instructions cause the processor to extract resolution information for resolving each of the one or more issues from one or more resolution databases. Subsequently, the instructions cause the processor to identify a portion of the resolution information missing in existing resolution information of the product manual based on a comparison of the resolution information with the existing resolution information. Finally, the instructions cause the processor to update the product manual with missing portion of the existing resolution information based on a logical resolution graph corresponding to the existing resolution information in the product manual.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The accompanying drawings, which are incorporated in and constitute a part of this disclosure, illustrate exemplary embodiments and, together with the description, explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1 illustrates an exemplary environment for dynamically updating a product manual in accordance with some embodiments of the present disclosure.

FIG. 2A shows a detailed block diagram illustrating an information updating system in accordance with some embodiments of the present disclosure.

FIG. 2B is an exemplary illustration of a logical resolution graph in accordance with some embodiments of the present disclosure.

FIG. 3 shows a flowchart illustrating a method of dynamically updating a product manual in accordance with some embodiments of the present disclosure.

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the specific forms disclosed, but on the contrary, the disclosure is to cover all modifications, equivalents, and alternatives falling within the spirit and the scope of the disclosure.

The terms “comprises”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure discloses a method and an information updating system for dynamically updating a product manual. In an embodiment, the present disclosure includes building a knowledge base from product manuals created by a manufacturer of the product and subsequently updating the product manual based on user reviews and updated product information fed by the manufacturer. The knowledge base may be built over a time based on user conversations, user feedback and query-resolution information with respect to specific product and specific product parts. In some embodiments, the present disclosure includes providing recommendations to the user based on user conversation history and user's expectations about the product. Additionally, the proposed disclosure includes identifying vulnerable portions of the product manuals, where there are issues/problems and adding adequate additional information on the vulnerable portions to enhance reliability of the product manuals.

Further, the present disclosure may enrich Frequently Asked Questions (FAQs) in the product manuals with additional questions and expanded information to make the product manuals more comprehensive. The expanded information may be text or a video indicating appropriate steps for resolving an issue. Hence, the product manuals get updated dynamically. However, if the steps are too detailed and no user is interested in the detailed FAQs, the additional, unused information may be dynamically omitted from the manual, causing the manual to shrink.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

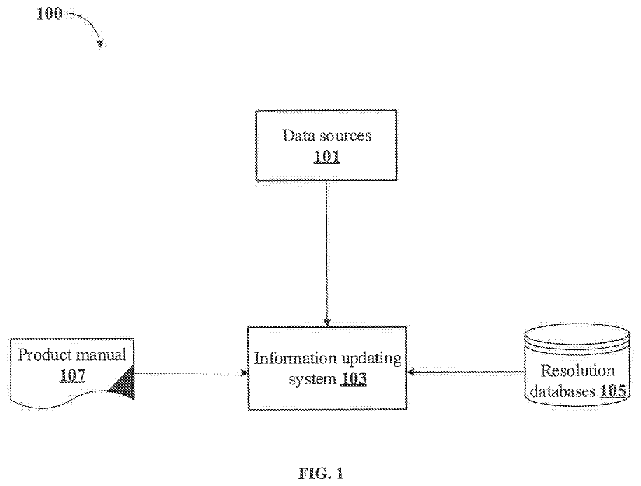

FIG. 1A illustrates an exemplary environment 100 for dynamically updating a product manual 107 in accordance with some embodiments of the present disclosure.

In some implementations, the environment 100 may include one or more data sources 101, an information updating system 103 and one or more resolution databases 105. In an embodiment, the one or more data sources 101 may include, without limiting to, user assistance systems and/or a customer care service centres, social media sites and social media profiles of users of a product and other user feedback platforms. That is, the one or more data sources 101 may be a combination of various online and offline data repositories that collect crucial information related to product from the users of the product. In some implementations, each of the one or more data sources 101 and the information updating system 103 may be connected over a communication network (not shown in FIG. 1).

In an embodiment, the information updating system 103 may be any computing device such as, without limiting to, a personal computer, a desktop computer, a server or a smartphone. In an embodiment, the information updating system 103 may be configured to receive the information related to the product from the one or more data sources 101 associated/connected with the information updating system 103. Subsequently, the information updating system 103 may analyze the information related to the product 103 using predetermined techniques for identifying one or more issues associated with handling the product. That is, the information updating system 103 identifies the one or more issues faced by the users of the product, based on the information related to the product 103. As an example, the predetermined techniques may include, without limiting to, Long Short-Term Memory (LSTM) classifier and relevant data classification techniques.

In an embodiment, upon identifying the one or more issues, the information updating system 103 may extract resolution information required for resolving each of the one or more issues from the one or more resolution databases 105. In other words, the information updating system 103 employs a problem-solution approach, wherein initially, the one or more issues (problems) are identified and subsequently the resolution information (solution) for solving the one or more issues are extracted. As an example, the one or more resolution databases 105 may include, without limiting to, log information corresponding to previously resolved issues, product manuals of similar products and resolutions provided by technical experts.

In an embodiment, once the resolution information is extracted from the one or more resolution databases 105, the information updating system 103 may refer to a product manual 107 corresponding to the product to extract existing resolution information from the product manual 107. Thereafter, the information updating system 103 may compare the resolution information with the existing resolution information to identify a missing portion of the existing resolution information. That is, the information updating system 103 may identify differences between the resolution information and the existing resolution information and determine the differences as the missing portion of the existing resolution information in the product manual 107.

In an embodiment, upon identifying the missing portion in the product manual 107, the information updating system 103 may update the product manual 107 with the missing portion of the existing resolution information based on a logical resolution graph corresponding to the existing resolution information in the product manual 107. In an embodiment, the logical resolution graph may be a data tree or a logical tree which indicates a list of plurality of components associated with the product, issues associated with the plurality of components and logical dependencies among the plurality of components. In other words, the logical resolution graph may be thought of an index to contents of the product manual 107, which clearly indicates hierarchical arrangement between the plurality of components and related information in the product manual 107. In an embodiment, the logical resolution graph may be used to determine a position of insertion, where the missing portion of the existing resolution information must be updated in the product manual 107.

Thus, the information updating system 103 implicitly assesses the one or more issues and inconvenience faced and/or expressed by the users of the product and determines additional information that must be included in the product manual 107. Thereafter, the information updating system 103 dynamically updates the product manual 107 with suitable resolution information, thereby assisting the users in overcoming the one or more issues and inconvenience associated with the handling/usage of the product. In other words, the present disclosure may be considered as a proactive approach to reduce inconvenience to the users by continuously updating the product manual 107 with the right type of additional details.

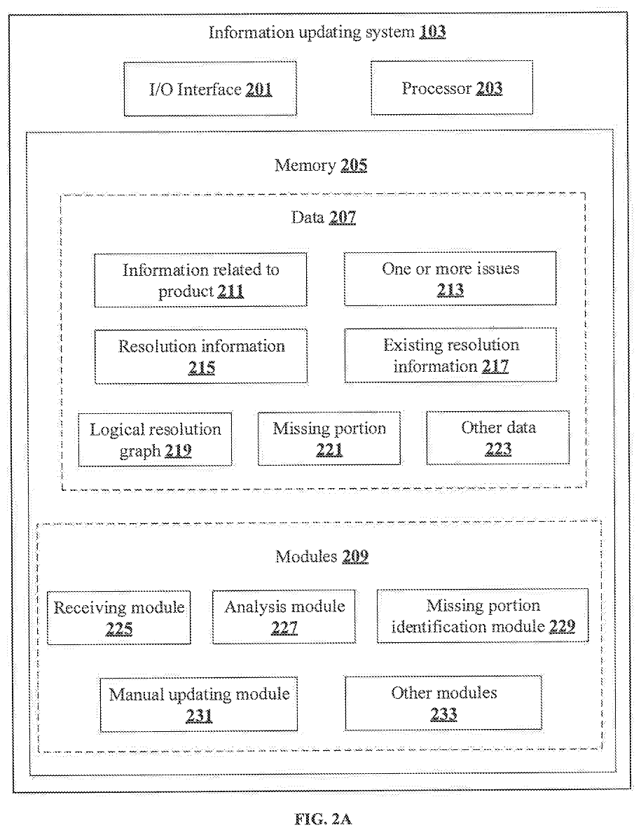

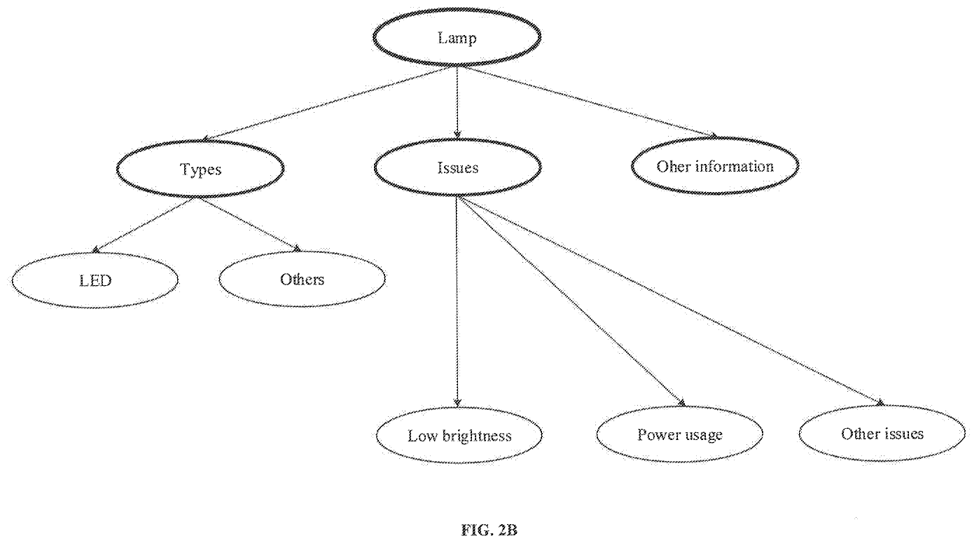

FIG. 2A shows a detailed block diagram illustrating an information updating system 103 in accordance with some embodiments of the present disclosure.

In some implementations, the information updating system 103 may include an I/O interface 201, a processor 203, and a memory 205. The I/O interface 201 may be configured to communicate with one or more data sources 101 to receive information related to the product 211. Further, the I/O interface 201 may be configured to communicate with one or more resolution databases 105 to extract resolution information 215 for resolving one or more issues 213 associated with the product. The memory 205 may be communicatively coupled to the processor 203 and may store data 207 and one or more modules 209. The processor 203 may be configured to perform one or more functions of the information updating system 103 while dynamically updating the product manual 107.

In an embodiment, the data 207 may include, without limitation, information related to the product 211, one or more issues 213, resolution information 215, existing resolution information 217, a logical resolution graph 219, missing portion 221 and other data 223. In some implementations, the data 207 may be stored within the memory 205 in the form of various data structures. Additionally, the data 207 may be organized using data models, such as relational or hierarchical data models. The other data 223 may store various temporary data and files generated by one or more modules 209 while performing various functions of the information updating system 103. As an example, the other data 223 may include, without limiting to, various versions of the product manual 107, one or more product-specific keywords, user sentiments and the like.

In an embodiment, the information related to the product 211 may include, without limiting to, at least one of user queries related to the product and user feedback on the product. The information related to the product 211 may be received from the one or more data sources 101 communicatively connected to the information updating system 103. In an embodiment, the information related to the product 211 may be used to derive useful information about usage and handling of the product. As an example, the user queries related to the product may be used to identify the one or more issues 213 faced by the users. Similarly, the user feedback on the product may be helpful in determining sentiments of the users towards the product. That is, the user feedback may indicate whether the users are happy with the usage of the product or if the users have a negative sentiment for the product.

In an embodiment, the one or more issues 213 are one or more faults in the product and/or one or more problems faced by the users of the product while handling the product. The one or more issues 213 may be identified based on analysis of the information related to the product 211 using the predetermined analysis techniques. In an embodiment, identifying the one or more issues 213 includes identifying one or more product-specific keywords, one or more user actions and corresponding user sentiments by processing the information related to the product 211. Thereafter, the one or more product-specific keywords, the one or more user actions and the corresponding user sentiments are correlated to identify the one or more issues 213 associated with handling the product.

In an embodiment, the resolution information 215 may include information required for resolving each of the one or more issues 213. The resolution information 215 may be extracted from the one or more resolution databases 105 connected with the information updating system 103.

In an embodiment, the existing resolution information 217 may include information that is already available on the product manual 107. As an example, the existing resolution information 217 may include, without limiting to, information related to working and handling of the product.

In an embodiment, the logical resolution graph 219 corresponding to the product manual 107 may include, without limiting to, a list of plurality of components associated with the product, one or more issues 213 associated with the plurality of components and logical dependencies among the plurality of components. That is, the logical resolution graph 219 reflects a logical connectivity between the plurality of components of the product and may be used to determine how each component influences the other components of the product. In an embodiment, the logical resolution graph 219 may be used to identify a position of insertion, where the missing portion 221 of the existing resolution information 217 may be updated in the product manual 107.

FIG. 2B shows an exemplary logical resolution graph 219 for a ‘Lamp’. As indicated in FIG. 2B, the logical resolution graph 219 of the ‘Lamp’ may include details related to various types of the lamps (LED or other types), one or more issues 213 associated with the lamp (low brightness, power usage and the like) and any other information specific to the ‘Lamp’. Such a logical resolution graph 219 provides a comprehensive overview of the product, which may be helpful while updating the product manual 107 of the product, as illustrated in the following example.

For example, suppose, a user of the ‘Lamp’ is facing an issue that, whenever the user switches on the ‘Lamp’, an Uninterruptible Power Supply (UPS) at his house trips/fails to function. Accordingly, the user may approach a customer support team concerned with the ‘Lamp’ and may raise a query about the issue being faced. The customer support team may find out that the issue is caused due to excessive power consumption by the ‘Lamp’, which is causing an overload on the UPS resulting in tripping of the UPS. Eventually, the customer support team may explain the user about the causes of the issue and may provide suitable resolutions to avoid the issue in future. Parallelly, the information updating system 103 may extract the resolutions provided by the customer support team and may compare them with existing contents of a product manual 107 of the ‘Lamp’ to determine if the resolution is already included in the product manual 107. Suppose, if the resolution is not present in the product manual 107, the information updating system 103 may dynamically update the resolution in the product manual 107 with the help of the logical resolution graph 219. Here, the logical resolution graph 219 may be used to determine an exact position where the resolution is to be updated in the product manual 107. Since the logical resolution graph 219 of ‘Lamp’ indicated in FIG. 2B is analogous to structure and/or organization of the product manual 107 of ‘Lamp’, the information updating system 103 may determine that the right position to update the resolutions is under heading ‘Issues>Power usage’. Thus, the logical resolution graph 219 may be used to quickly and accurately determine the position where a missing portion 221 of the product manual 107 may be updated.

Additionally, the logical resolution graph 219 may be used to find the right kind of response to be provided for user queries. Further, when there are multiple queries in a single user utterance and the user query translates into multiple subqueries, the response for each of the subqueries may be found by traversing the logical resolution graph 219 multiple times. For example, consider an issue faced by the user such as—“whenever the oven is switched on, there will be a loud noise and also burning smell”. The above issue translates into two sub-issues—‘loud noise’ and ‘burning smell’. However, both the issues may be caused by the same reason, such as friction in a moving part (bearing) of the oven, leading to overheating. Thus, in the above scenario, the logical resolution graph 219 may be traversed only once to fetch the resolution information 215 which addresses the issue with a ‘moving part’ of the oven.

In an embodiment, the missing portion 221 may be a portion of the resolution information 215 that is not present in the existing resolution information 217 of the product manual 107. The missing portion 221 may be identified based on comparison of the resolution information 215 with the existing resolution information 217. Further, the missing portion 221 of the existing resolution information 217 may be updated in the product manual 107, such that the product manual 107 includes resolution information 215 required for solving the one or more issues 213.

In an embodiment, each of the data 207 may be processed by the one or more modules 209. In some implementations, the one or more modules 209 may be communicatively coupled to the processor 203 for performing one or more functions of the information updating system 103. In an implementation, the one or more modules 209 may include, without limiting to, a receiving module 225, an analysis module 227, a missing portion identification module 229, an updating module 231 and other modules 233.

As used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality. In an embodiment, the other modules 233 may be used to perform various miscellaneous functionalities of the information updating system 103. It will be appreciated that such one or more modules 209 may be represented as a single module or a combination of different modules.

In an embodiment, the receiving module 225 may be configured to receive the information related to the product 211 from the one or more data sources 101 associated with the information updating system 103. Further, the receiving module 225 may be used to extract the resolution information 215 required for resolving each of the one or more issues 213 from the one or more resolution databases 105. Additionally, the receiving module 225 may be used to retrieve the product manual 107 of a product, if the product manual 107 is not available at the information updating system 103. In some implementations, the receiving module 225 may function as an online content reviewer to analyse and extract product relevant information from social media sites and social media profiles of the users. Also, the receiving module 225 may function as a query analyser, which collects user queries and user reviews and feedback from user assistance systems and feedback platforms.

In an embodiment, the analysis module 227 may be configured for analyzing the information related to the product 211 for identifying the one or more issues 213 associated with handling the product. As a first step of analysis, the analysis module 227 may separate out relevant product information from the ones that are not related to the product. This analysis may be performed using a pre-trained classifier technique configured in the analysis module 227. As an example, the classifier technique may be a Long Short-Term Memory (LSTM) classifier. Alternatively, the analysis module 227 may be configured with any other classifier technique configured in the analysis module 227. Subsequently, the analysis module 227 may extract information such as product-specific keywords, one or more user actions and corresponding user sentiment from the relevant product information. Thereafter, the product-specific keywords, the one or more user actions and the corresponding user sentiment may be correlated to identify the one or more issues 213 associated with handling the product.

In some implementations, the classifier technique configured in the analysis module 227 may be pre-trained with the product manual 107 of the product for training the analysis module 227 to accurately recognize product relevant information. Subsequently, when user utterances, in the form of user queries and user feedback, are forwarded to the analysis module 227, the analysis module 227 may map the user utterances with the pre-trained information to extract only the product-specific information. In other words, upon successful training, the analysis module 227 may effectively segregate the information related to the product 211 and may extract only the product-specific information required to identify the one or more issues 213.

In one illustration, a user utterance such as “good morning, I am John” may be classified as technically non-relevant to the product and discarded from further analysis. Whereas, a subsequent user utterance such as “I got an electric shock while inserting plug of the refrigerator” may be classified as a product-specific information and taken forward for further analysis. Here, once the product-specific information is detected, the analysis module 227 may classify each subsequent user utterance as relevant to the product and may extract product-specific keywords, actions and user sentiment from the subsequent user utterances.

The analysis module 227 may analyze the product relevant information based on following three-step process:

Identification of Product-Specific Keywords:

The product-specific keywords may be identified by comparing the user utterance with a domain-specific dictionary constructed from an existing product manual 107. In the same illustration mentioned above, the words ‘Refrigerator’ and ‘plug’ in the user utterances may be identified as the product-specific keywords.

Identification of Actions Involved:

This analysis may be performed by identifying verbs in the user utterance by parsing the user utterance. In the same illustration mentioned above, the words like ‘inserting’ and ‘got’ (auxiliary verb) in the user utterances may be identified as the actions involved in handling the product.

Identification of the Issues:

The issues may be identified by analyzing effect of the actions on the product, and the sentiment expressed by the user. Here, the product manual 107 and the pre-trained classifier may be used to identify an association between the product and sentiment expressed by the user. For example, in the above user utterance, the user has expressed a negative sentiment towards the ‘Refrigerator’ and the ‘plug’, and hence the analysis module 227 may identify that there is an issue with ‘insertion of refrigerator plug’.

In an embodiment, for non-interactive information captured over social media sites, user feedback emails and the like, degree of emotion associated with each user utterance may be important for identification of the issues. Here, the non-interactive user statements may be analyzed to determine negative sentiments and reasons for the negative statement to effectively identify the issues faced by the users. Once the negative sentiments and the associated reasons are identified, remedial actions required for addressing the negative sentiments may be provided to the users by updating the product manual 107 with relevant resolution information 215.

In an embodiment, analyzing the information related to the product 211 for identifying negative and/or positive user sentiments involves the following process:

Identification of Product-Specific Statements/Information:

Identification of the product-specific statements involves extraction of the product related details from the relevant sentences. For example, consider the following statements:

“Hello, I am John. Every year, I buy devices. This year I bought a Laptop. The model is SUN 2276X”.

Out of these statements, the first sentence—“Hello, lam John” may be discarded from the analysis since it is irrelevant to the product. The second sentence—“Every year, I buy devices” may be retained as it reveals some information like when the user might have bought the product. However, only the last two sentences—“This year I bought a Laptop. The model is SUN 2276X” indicate actual product-specific details and may be retained for further analysis. The product-specific information extracted from the above statements may be classified as shown in Table A below:

TABLE A
Extraction of product-specific information

| Product | Connected sentence |
|---|---|
| Laptop | This year I bought a Laptop. The model is |
| | SUN 2276X |

Classification of the product-specific information as shown in Table A helps in building clusters of sentences related to the product and ensures that each of the product-specific sentences are connected. In an embodiment, grouping of related sentences may be performed based on the Part-of-Speech (POS) tags. Here, each POS tag may refer to a product or a name of the product (such as Laptop) and may be populated under column ‘Product’ in the table. Further, any sentence which refers to the already tagged ‘Product’ may be considered as a relevant to the product and placed together in the table, thereby grouping all the related sentences.

Quantification of Sentiments and Feedback:

In this analysis step, the sentiments associated with the connected sentences are extracted based on the information stored in Table A. The sentiment analysis may involve training an LSTM model based on historical sentiment data available with the information updating system 103. Upon training, the LSTM model may be used to determine if a sentence has a positive sentiment, negative sentiment or neutral sentiment. Further, to compute a consolidated parameter of the sentiment, a weighted sum of two parameters may be considered. First parameter may be percentage of sentences giving positive feedback out of total number of products. Second parameter may be total number of sentences about the product.

In an embodiment, the first parameter may reflect the effectiveness of the sentiment. For example, if there are three sentences and in all the three sentences the user is expressing his displeasure over the working of a part of the product, then the sentence may be treated with higher priority. Although length of the user feedback is implicitly considered here, absolute length of feedback may be required to be credited since the user may have put some efforts to provide a lengthy feedback. In an embodiment, a lengthy user feedback may mean that the user has made a genuine effort in reviewing the product and stating the issues faced while handling the product.

In an embodiment, the missing portion identification module 229 may be used for identifying a missing portion 221 of the existing resolution information 217 in the product manual 107. Initially, the missing portion identification module 229 may extract resolution information 215 required for resolving each of the one or more issues 213 from the one or more resolution databases 105 connected to the information updating system 103. Subsequently, the missing portion identification module 229 may refer to the product manual 107 corresponding to the product for extracting the existing resolution information 217 in the product manual 107. Thereafter, the missing portion identification module 229 may compare the resolution information 215 with the existing resolution information 217 to identify the missing portion 221 of the existing resolution information 217 in the product manual 107.

Here, the missing portion identification module 229 may extract the resolution information 215 from the one or more resolution databases 105 according to extent/degree of user sentiments identified in the information related to the product 211. For example, if a statement such as “I received a shock while I was trying to insert the electric plug”, is received from a number of users, then it may be determined that additional information on “plug insertion” needs to be included in the product manual 107. Further, based on the degree of sentiment observed in the user feedback, the users may be warned of “getting shocked”. Finally, based on the existing resolution information 217 in the product manual 107 and the logical resolution graph 219 of the product manual 107, a position of insertion for the additional information may be determined.

Further, as an example, consider a user statement such as “When the switch is pressed for more than 4 seconds, the display goes off. It is not mentioned anywhere in the user manual”. And a user utterance such as “If I release the switch before 4 seconds, the display stays, otherwise it goes off”. Here, in both the statements, the components involved are ‘Switch’ and ‘Display’. The action involved is ‘pressing of the switch’, the issue identified is ‘vanishing of the display’, and the sentiment is ‘negative’. Therefore, any portion of the product manual 107 which mentions ‘Switch’ and ‘Display’ must be checked to determine if sufficient information regarding the issues stated by the users are present in the product manual 107. However, if the product manual 107 does not contain sufficient information on the issue, then additional resolution information 215 must be extracted and added to the product manual 107. For example, suppose the resolution information 215 for addressing the above issue is “switch press time is to be less than 4 seconds for the display to work”. This resolution information 215 may be updated in a position which has details about ‘Switch’ and ‘Display’ in the product manual 107. The position of insertion, as illustrated above, may be located based on the logical resolution graph 219 comprising hierarchical representation of the ‘Switch’ and the ‘Display’.

In an embodiment, the updating module 231 may be configured for updating the product manual 107 with the missing portion 221 of the existing resolution information 217. The missing portion 221 may be updated based on the logical resolution graph 219 corresponding to the existing resolution information 217 in the product manual 107. Once the missing portion 221 of the existing resolution information 217 is identified, the updating module 231 may refer to the logical resolution graph 219 to get the position of insertion where the missing portion 221 is to be updated. The updating module 231 may also be configured to handle any contradictions resulting from updating of the missing portion 221. The updating module 231 may use the logical resolution graph 219 to ensure that the information in FAQ section of the product manual 107, which caters to interactive user queries are in sync with the updated information of the product manual 107.

In an embodiment, the updating module 231 may fetch the additional details/resolution information 215 to be updated in the product manual 107 from product manuals of similar products. For example, if the issue of inserting electric plug in the socket for an ‘LCD display monitor’ exists for an ‘LCD TV’ as well, then the required resolution information 215 may be retrieved from the product manual 107 of the LCD TV. Here, the updating module 231 may initiate an internal search for the issue—“insertion of an electrical plug into socket” over other product manuals available in the knowledge base, to find the required resolution information 215.

Further, the updating module 231 may check appropriateness of the found results in the context of the issue, before updating the resolution information 215 to the existing product manual 107. If attributes of a product found in the search results are different, for example, say the ‘LCD display monitor’ uses a square pin socket, but the ‘LCD TV’ uses a round pin socket, then the search results may be discarded. In such instances, assistance from the technical domain experts may be sought before updating the product manual 107. Additionally, the updating module 231 may also provide notifications to the users of the product, each time the product manual 107 is updated with additional information.

Exemplary Scenario—1

Suppose, John—a user, bought a mixer grinder and tried to powder dried peas. However, the blades of the mixer grinder got stuck as John used an inappropriate jar for grinding the peas. The product manual 107 of the mixer grinder did not have any information related to the type of jars that must be used for grinding different items. Therefore, John highlights the same issue on social media. In this scenario, the method of the present disclosure may be used to help John to identify the right type of jar for grinding the peas along with recommended quantity of loads. Subsequently, the information provided to John may be dynamically updated in the product manual 107, as well as in FAQs associated with the mixer grinder, using s logical resolution graph 219 of the product ‘Mixer grinder’.

Use Case Scenario—2

Suppose, Tom—a user, bought a laptop which comes with a square-pin charger. However, the socket at his home fits round pins, making the laptop charger unusable. Therefore, Tom contacts customer support, who advises him to use a universal adaptor. Tom's issue was resolved with the resolution provided by the customer support. Accordingly, the information updating system 103 of the present disclosure may extract the resolution provided to Tom and may dynamically update the same in the product manual 107 of the laptop. Here, the resolution information 215 may be updated in the product manual 107 under the heading—‘power supply’ as “use a universal adaptor if socket holes are round type”. Thereafter, users who face similar issues would refer to the updated product manual 107 and resolve the issue, without the help of customer support.

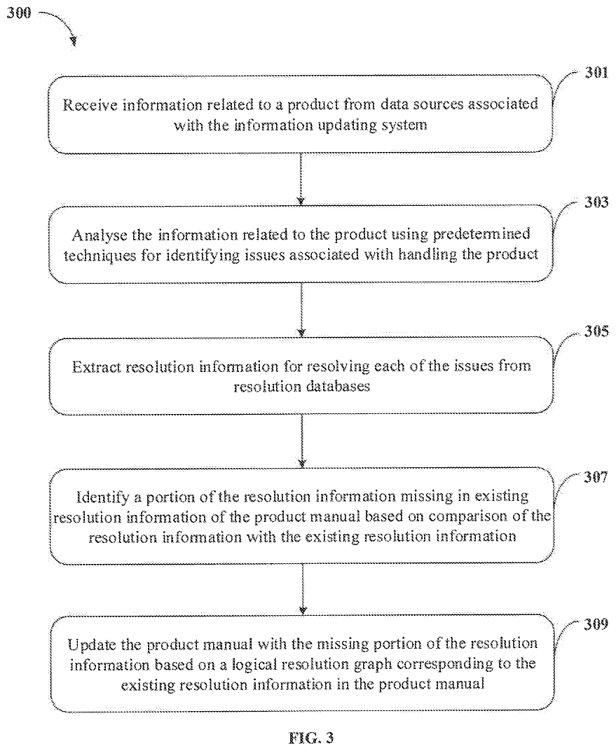

FIG. 3 shows a flowchart illustrating a method of dynamically updating a product manual 107 in accordance with some embodiments of the present disclosure.

As illustrated in FIG. 3, the method 300 may include one or more blocks illustrating the method of dynamically updating the product manual 107 using an information updating system 103 shown in FIG. 1. The method 300 may be described in the general context of computer-executable instructions. Generally, computer-executable instructions can include routines, programs, objects, components, data structures, procedures, modules, and functions, which perform specific functions or implement specific abstract data types.

The order in which the method 300 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 301, the method 300 includes receiving, by the information updating system 103, information related to a product from one or more data sources 101 associated with the information updating system 103. As an example, the one or more data sources 101 may include, without limiting to, at least one of user assistance systems, social media sites and user feedback platforms. In an embodiment, the information related to the product 103211 may include at least one of user queries related to the product and user feedback on the product.

At block 303, the method 300 includes analyzing, by the information updating system 103, the information related to the product 103211 using predetermined techniques for identifying one or more issues 213 associated with handling the product. In an embodiment, analysing the information related to the product 103211 may include processing the information related to the product 103211 for identifying one or more product-specific keywords, one or more user actions, and corresponding user sentiment. Subsequently, the one or more issues 213 associated with handling the product may be identified based on correlation among the one or more product-specific keywords, the one or more user actions, and the corresponding user sentiment.

At block 305, the method 300 includes extracting, by the information updating system 103, resolution information 215 for resolving each of the one or more issues 213 from one or more resolution databases 105. As an example, the one or more resolution databases 105 may include, without limiting to, at least one of log information corresponding to previously resolved issues, product manuals of similar products, and resolutions provided by technical experts.

At block 307, the method 300 includes identifying, by the information updating system 103, a missing portion 221 of the existing resolution information 217 for including in the product manual 107 based on a comparison of the resolution information 215 with the existing resolution information 217 in the product manual 107.

At block 309, the method 300 includes updating, by the information updating system 103, the product manual 107 with the missing portion 221 of the existing resolution information 217 based on a logical resolution graph 219 corresponding to the existing resolution information 217 in the product manual 107. In an embodiment, the logical resolution graph 219 may include a list of plurality of components associated with the product, issues associated with the plurality of components, and logical dependencies among the plurality of components. Further, updating the product manual 107 may include identifying a position of insertion using the logical resolution graph 219 for updating the missing portion 221 of the existing resolution information 217 in the product manual 107.

In an embodiment, the information updating system 103 may further include providing real-time notification to users of the product whenever there are any updates in the product manual 107.

Computer System

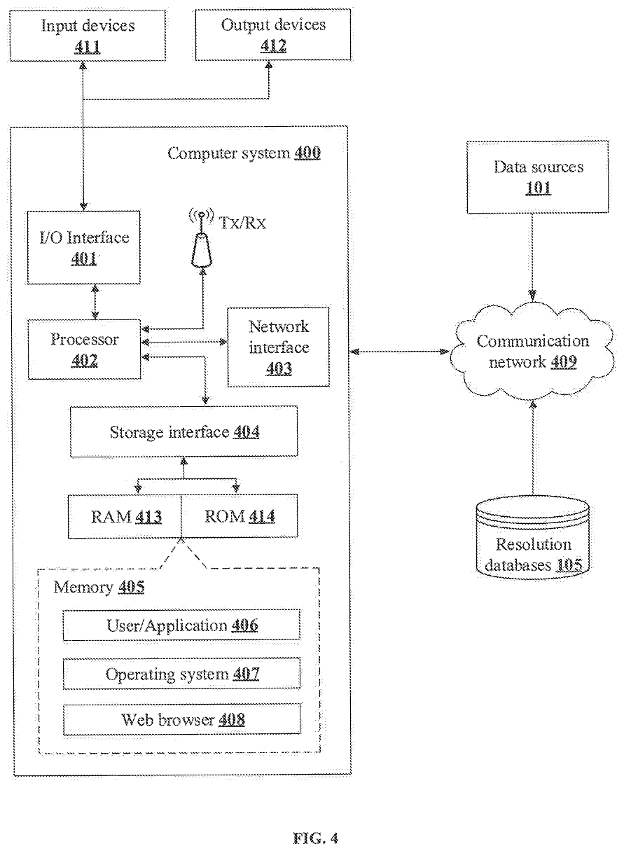

FIG. 4 illustrates a block diagram of an exemplary computer system 400 for implementing embodiments consistent with the present disclosure. In an embodiment, the computer system 400 may be an information updating system 103 shown in FIG. 1, which may be used for dynamically updating a product manual 107. The computer system 400 may include a central processing unit (“CPU” or “processor”) 402. The processor 402 may comprise at least one data processor for executing program components for executing user- or system-generated business processes. A user may include a person, a user in the environment 100, a user of any product or any system/sub-system being operated parallelly to the computer system 400. The processor 402 may include specialized processing units such as integrated system (bus) controllers, memory management control units, floating point units, graphics processing units, digital signal processing units, etc.

The processor 402 may be disposed in communication with one or more input/output (UO) devices (411 and 412) via I/O interface 401. The I/O interface 401 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE® 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc. Using the I/O interface 401, the computer system 400 may communicate with one or more I/O devices 411 and 412.

In some embodiments, the processor 402 may be disposed in communication with a communication network 409 via a network interface 403. The network interface 403 may communicate with the communication network 409. The network interface 403 may employ connection protocols including, without limitation, direct connect, Ethernet (e.g., twisted pair 10/100/1000 Base T), Transmission Control Protocol/Internet Protocol (TCP/IP), token ring, IEEE® 802.11 a/b/g/n/x, etc. Using the network interface 403 and the communication network 409, the computer system 400 may be connected to one or more data sources 101 for receiving information related to the product 211. Further, the computer system 400 may use the communication network 409 to communicate with one or more resolution databases 105 for extracting resolution information 215 corresponding to one or more issues 213 in the product.

In an implementation, the communication network 409 can be implemented as one of the several types of networks, such as intranet or Local Area Network (LAN) and such within the organization. The communication network 409 may either be a dedicated network or a shared network, which represents an association of several types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 409 may include a variety of network devices, including routers, bridges, servers, computing devices, storage devices, etc.

In some embodiments, the processor 402 may be disposed in communication with a memory 405 (e.g., RAM 413, ROM 414, etc. as shown in FIG. 4) via a storage interface 404. The storage interface 404 may connect to memory 405 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user/application interface 406, an operating system 407, a web browser 408, and the like. In some embodiments, computer system 400 may store user/application data 406, such as the data, variables, records, etc. as described in this invention. Such databases may be implemented as fault-tolerant, relational, scalable, secure databases such as Oracle® or Sybase®.

The operating system 407 may facilitate resource management and operation of the computer system 400. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD®, etc.), LINUX® DISTRIBUTIONS (E.G., RED HAT®, UBUNTU®, KUBUNTU®, etc.), IBM® OS/2®, MICROSOFT® WINDOWS® (XP®, VISTA®/7/8, 10 etc.), APPLE® IOS®, GOOGLE™ ANDROID™, BLACKBERRY® OS, or the like.

The user interface 406 may facilitate display, execution, interaction, manipulation, or operation of program components through textual or graphical facilities. For example, the user interface 406 may provide computer interaction interface elements on a display system operatively connected to the computer system 400, such as cursors, icons, checkboxes, menus, scrollers, windows, widgets, and the like. Further, Graphical User Interfaces (GUIs) may be employed, including, without limitation, APPLE® MACINTOSH® operating systems, Aqua®, IBM® OS/2®, MICROSOFT® WINDOWS® (e.g., Aero, Metro, etc.), web interface libraries (e.g., ActiveX, JAVA®, JAVASCRIPT®, AJAX, HTML, ADOBE® FLASH®, etc.), or the like.

The web browser 408 may be a hypertext viewing application. Secure web browsing may be provided using Secure Hypertext Transport Protocol (HTTPS), Secure Sockets Layer (SSL), Transport Layer Security (TLS), and the like. The web browsers 408 may utilize facilities such as AJAX, DHTML, ADOBE® FLASH®, JAVASCRIPT®, JAVA®, Application Programming Interfaces (APIs), and the like. Further, the computer system 400 may implement a mail server stored program component. The mail server may utilize facilities such as ASP, ACTIVEX®, ANSI® C++/C#, MICROSOFT®, .NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 400 may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, and the like.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Advantages of the Embodiment of the Present Disclosure are Illustrated Herein.

In an embodiment, the present disclosure provides a method of dynamically updating a product manual or a user guide of a product.

In an embodiment, the method of present disclosure takes into consideration online user reviews, user feedback and issues faced by the users to dynamically identify missing information in the product manual and automatically updates the product manuals without any human intervention. Thus, the present disclosure addresses the issues faced by the users while understanding cryptic information in the product manual.

In an embodiment, the method of present disclosure helps in better understanding of user behavior and sentiments towards a product and reduces number of field calls to be handled by the customer executives.

In an embodiment, the method of present disclosure helps in building comprehensive product manuals for the products, thereby enhancing reliability of the product manuals and usability of the products.

In an embodiment, the method of present disclosure helps designers and/or manufacturers of a product in identifying most vulnerable parts/components of a product based on analysis of issues raised by users of the product.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to” unless expressly specified otherwise.

The enumerated listing of items does not imply that any or all the items are mutually exclusive unless expressly specified otherwise. The terms “a”, “an” and “the” mean “one or more” unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference Number | Description |
|---|---|
| 100 | Environment |
| 101 | Data sources |
| 103 | Information updating system |
| 105 | Resolution databases |
| 107 | Product manual |
| 201 | I/O interface |
| 203 | Processor |
| 205 | Memory |
| 207 | Data |
| 209 | Modules |
| 211 | Information related to product |
| 213 | One or more issues |
| 215 | Resolution information |
| 217 | Existing resolution information |
| 219 | Logical resolution graph |
| 221 | Missing portion |
| 223 | Other data |
| 225 | Receiving module |
| 227 | Analysis module |
| 229 | Missing portion identification module |
| 231 | Updating module |
| 233 | Other modules |
| 400 | Exemplary computer system |
| 401 | I/O Interface of the exemplary computer system |
| 402 | Processor of the exemplary computer system |
| 403 | Network interface |
| 404 | Storage interface |
| 405 | Memory of the exemplary computer system |
| 406 | User/Application |
| 407 | Operating system |
| 408 | Web browser |
| 409 | Communication network |
| 411 | Input devices |
| 412 | Output devices |
| 413 | RAM |
| 414 | ROM |

What is claimed is:

1. A method of dynamically updating a product manual, the method comprising:
receiving, by an information updating system, information related to a product from one or more data sources associated with the information updating system;
analysing, by the information updating system, the information related to the product using predetermined techniques for identifying one or more issues associated with handling the product;
extracting, by the information updating system, resolution information for resolving each of the one or more issues from one or more resolution databases;
identifying, by the information updating system, a portion of the resolution information missing in existing resolution information of the product manual based on a comparison of the resolution information with the existing resolution information; and
updating, by the information updating system, the product manual with missing portion of the existing resolution information based on a logical resolution graph corresponding to the existing resolution information in the product manual.

2. The method as claimed in claim 1, wherein the information related to the product comprises at least one of user queries related to the product and user feedback on the product.

3. The method as claimed in claim 1, wherein analysing the information related to the product comprises:
processing the information related to the product for identifying one or more product-specific keywords, one or more user actions, and corresponding user sentiment; and
identifying the one or more issues associated with handling the product based on correlation among the one or more product-specific keywords, the one or more user actions, and the corresponding user sentiment.

4. The method as claimed in claim 1, wherein the one or more data sources include at least one of user assistance systems, social media sites, or user feedback platforms.

5. The method as claimed in claim 1, wherein the one or more resolution databases comprise at least one of log information corresponding to previously resolved issues, product manuals of similar products, or resolutions provided by technical experts.

6. The method as claimed in claim 1, wherein the logical resolution graph comprises a list of plurality of components associated with the product, issues associated with the plurality of components, and logical dependencies among the plurality of components.

7. The method as claimed in claim 1, wherein updating the product manual comprises identifying a position of insertion in the logical resolution graph for updating the missing portion of the existing resolution information in the product manual.

8. The method as claimed in claim 1 further comprises providing real-time notification to users of the product about updates in the product manual.

9. An information updating system for dynamically updating a product manual, the information updating system comprising:
a processor; and
a memory, communicatively coupled to the processor, wherein the memory stores processor-executable instructions, which on execution, cause the processor to:
receive information related to a product from one or more data sources associated with the information updating system;
analyse the information related to the product using predetermined techniques to identify one or more issues associated with handling the product;
extract resolution information for resolving each of the one or more issues from one or more resolution databases;
identify a portion of the resolution information missing in existing resolution information of the product manual based on a comparison of the resolution information with the existing resolution information; and
update the product manual with missing portion of the existing resolution information based on a logical resolution graph corresponding to the existing resolution information in the product manual.

10. The information updating system as claimed in claim 9, wherein the information related to the product comprises at least one of user queries related to the product and user feedback on the product.

11. The information updating system as claimed in claim 9, wherein to analyse the information related to the product, the processor is configured to:
process the information related to the product to identify one or more product-specific keywords, one or more user actions, and corresponding user sentiment; and
identify the one or more issues associated with handling the product based on correlation among the one or more product-specific keywords, the one or more user actions, and the corresponding user sentiment.

12. The information updating system as claimed in claim 9, wherein the one or more data sources include at least one of user assistance systems, social media sites, or user feedback platforms.

13. The information updating system as claimed in claim 9, wherein the one or more resolution databases comprise at least one of log information corresponding to previously resolved issues, product manuals of similar products, or resolutions provided by technical experts.

14. The information updating system as claimed in claim 9, wherein the logical resolution graph comprises a list of plurality of components associated with the product, issues associated with the plurality of components, and logical dependencies among the plurality of components.

15. The information updating system as claimed in claim 9, wherein the processor identifies a position of insertion in the logical resolution graph to update the missing portion of the existing resolution information in the product manual.

16. The information updating system as claimed in claim 9, wherein the processor provides real-time notification to users of the product about updates in the product manual.

17. A non-transitory computer readable medium including instructions stored thereon that when processed by at least one processor, cause an information updating system to perform operations comprising:
receiving information related to a product from one or more data sources associated with the information updating system;
analysing the information related to the product using predetermined techniques to identify one or more issues associated with handling the product;
extracting resolution information for resolving each of the one or more issues from one or more resolution databases;
identifying a portion of the resolution information missing in existing resolution information of the product manual based on a comparison of the resolution information with the existing resolution information; and
updating the product manual with missing portion of the existing resolution information based on a logical resolution graph corresponding to the existing resolution information in the product manual.
